(19) United States
(12) Patent Application Publication
(10) Pub. No.: US 2007/0011138 A1
(43) Pub. Date: Jan. 11, 2007

(54) System and method for interactive data management

(76) Inventor: John Christian Boucard, Pasadena, CA (US)

Correspondence Address: CHRISTIE, PARKER & HALE, LLP, PO BOX 7068, PASADENA, CA, 91109-7068, US

(21) Appl. No.: 11/483,042

(22) Filed: Jul. 7, 2006

Related U.S. Application Data
(60) Provisional application No. 60/697,198, filed on Jul. 7, 2005.

(51) Int. Cl. G06F 17/30

(52) U.S. Cl. 707/1

(57) ABSTRACT

A method and system for linking an article to data, for example, multimedia data. The system includes a processor with a memory; a plurality of storage mediums operatively coupled to said processor; a readable memory device included with the article, the memory device including an identifier and a pointer, wherein the identifier uniquely identifies the article and the pointer links to one or more locations of data related to a user-defined profile; a reader for reading the identifier and pointer; and an output device operably coupled to said processor for outputting the data related to the user-defined profile. The article may include an object representative of the data related to the user-defined profile and the memory device may be embedded in the object. The article may also include a tag including the memory device and means for attachment to an object.

### CROSS REFERENCE TO RELATED APPLICATIONS

The present Patent Application claims the benefit of priority of Provisional Patent Application Ser. No. 60/697,198 filed Jul. 7, 2005, and entitled “INTERACTIVE DATA MANAGEMENT SYSTEM”, the entire content of which is expressly incorporated herein by reference.

### FIELD OF THE INVENTION

The invention relates to an interactive data management system that provides simultaneous access to all relevant multimedia data content located in one or more storage mediums.

### BACKGROUND OF THE INVENTION

Currently, multimedia and other data content are distributed on storage mediums such as a USB Stick, CD, VCD or DVD, and have traditionally been viewed and listened to on a television set, monitor, personal computer, or the like. The internet has added the ability to locate content by a uniform resource locator (URL). Usually, data, audio and video content stored on specific media are organized by hierarchical menus and can be accessed selectively using a remote access device such as an infrared (IR) remote control, mouse or keyboard. These devices typically have buttons or keys that allow the user to navigate through a hierarchal menu structure to select the desired content and activate the commands that will enable the content to be presented.

Content, however, is often stored in more than one location and one type of storage media. Therefore, in order to present a complete user experience, related content must first be identified and then selectively accessed using an appropriate media player or storage device before the user is presented with the content. For example, if a couple desires to remember their lives together, they must gather all the related articles such as photographs, videos, letters, e-mails and notes together, then sort through the collection in a particular order, then view the collection after it has been organized. This process can be very tedious and time consuming.

Previous attempts such as those in the system and device of United States Patent Application No. 2003/0115293 A1 limit the content that can be delivered to local CD-ROM drives and the internet. Further, the system directs a consumer to specific corporate advertising and does not link an article to all relevant files that pertain to the article.

Accordingly, there is a need for an interactive data management system that can link an article to all files that pertain to the article from disparate locations and various formats in a user selectable order.

### SUMMARY

In one embodiment, the present invention is a system for linking an article to data, for example, multimedia data. The system includes a processor with a memory; a plurality of storage mediums operatively coupled to said processor; a readable memory device included with the article, the memory device including an identifier and a pointer, wherein the identifier uniquely identifies the article and the pointer links to one or more locations of data related to a user-defined profile; a reader for reading the identifier and pointer; and an output device operably coupled to said processor for outputting the data related to the user-defined profile. The article may include an object representative of the data related to the user-defined profile and the memory device may be embedded in the object. The article may also include a tag including the memory device and means for attachment to an object.

In one embodiment, the present invention is an article of manufacture including: an identifier; and a pointer, wherein the identifier uniquely identifies the article and the pointer identifies one or more locations of all data content associated with the article. The article may include a physical representation of the stored content.

In one embodiment, the present invention is an interactive data management system. The system includes storage means responsive to an article remote from the storage means, the article including an identifier and a pointer for storing a plurality of data sets each related to a user-designated profile, each of said data sets being stored at a different designated storage location; and means responsive to said identifier for activating the data sets at said storage locations according to a preset user preference.

In one embodiment, the present invention is a method for storing related content elements in various storage mediums. The method includes identifying content elements as belonging to a user identified profile; storing each content element at a storage location in memory encoded as belonging to the profile; collecting the storage locations at a profile address; transmitting a signal linked to the profile address; and publishing the content elements in the locations stored at the profile address responsive to the signal. The method may further include storing in a readable memory device an identifier and a pointer linked to the profile address.

In one embodiment, the present invention is a device for linking an article to a plurality of content elements stored in various mediums coupled to a processor having a memory. The device includes a base; means for attaching the base to an object; a memory for storing an identifier and a pointer, wherein the identifier uniquely identifies the device and the pointer links to a profile at which the locations of all said plurality of content elements are stored; and a reader for reading the identifier and the pointer, wherein the processor accesses said plurality of content elements responsive to the identifier and the pointer read by the reader. The memory may store a plurality of pointers each linked to a different profile address, and the device may include a switch for selecting a single one of the plurality of pointers.

### BRIEF DESCRIPTION OF THE DRAWINGS

FIG. 1 is a schematic block diagram of a system operative in accordance with one embodiment of the invention;

FIGS. 2, 5 and 6 are schematic representations of readable memory devices;

FIG. 3 is a flow diagram of the software for encoding multimedia content locations for collection in accordance with one embodiment of the invention;

FIG. 4 is a flow diagram of the software for encoding a memory device in accordance with one embodiment of the invention;

FIG. 7 is a schematic representation of various location collectives in accordance with one embodiment of the invention;

FIG. 8 is a chart of pointer examples and related profile addresses; and

FIG. 9 is a block diagram for a remote controller application of the present invention;

FIG. 10 is a block diagram for a game application of the present invention;

FIG. 11 is a block diagram for a clip board application of the present invention;

FIG. 12 is a block diagram for a USB stick application of the present invention;

FIG. 13 is a block diagram for a multimedia player application of the present invention;

FIGS. 14A and 14B are block diagrams for a game application involving an unique storage means and access to content of the present invention;

FIG. 15 is a block diagram for a set top box application of the present invention; and

FIG. 16 is a block diagram for a greeting card application of the present invention.

### DETAILED DESCRIPTION

Co-pending United States Patent Application No. 2005/0273553 filed Apr. 12, 2005, describes direct access to a single data set (content) without navigating through a menu. The present application extends this access to simultaneous access of multiple data sets previously stored by a user in a manner permissive of simultaneous access, among others.

The present invention is capable of collecting content storage locations at a profile address, accessing the profile address via one or more identifiers and pointers, using multiple pointers along with a switch for selecting a particular pointer and managing the related content software responsive to the identifier(s) and pointer(s).

Simultaneous access is permitted by storing data sets or content in multimedia space at storage locations each of which is encoded as belonging to a user-defined profile. The storage locations are collected in memory at an address called the “profile address” herein. The profile address is accessed by a memory device, which can be wireless or physically connected. The memory device includes an identifier identifying the memory device and a pointer linked to the profile address.

Access to the profile address is controlled by software conveniently stored in a processor (for example, in a USB Stick, a personal computer, or the like) to which the multimedia subsystems are connected. The software responds to the identifier to allow the pointer to link to the address at which the locations are stored and to express the content of the storage locations in accordance with previously stored user preferences.

In one embodiment, a (remote) memory device includes a plurality of pointers, each linked to a different profile address. The memory device includes a switch to permit a user to select one of a plurality of profiles in the system.

The memory device, including the identifier and a pointer, may comprise a tag structure which may be attached to an object (illustratively by adhesive) or may be embedded in an object representative of the profile content. In one embodiment, the memory device, including the identifier and pointer, may be a USB Stick.

The term “access device” or “memory device” refers to any device capable of containing an identifier and a pointer. For example, a trading card with a magnetic storage strip; a wearable jewelry with a RFID tag; a photograph with a bar code; a greeting card, a toy figure with an internal radio frequency (RF) transmitter; a USB Stick or a children's power ring device adapted to communicate with a TV set, an infrared (IR) remote control; and the like.

The term URL refers to a Uniform Resource Locator and is an example of a pointer. The term (URL) identifies a resource and indicates how to locate it, such as, for example, a standardized address format for referring to resources, such as documents and images by their location. The term URL is also used outside the context of the World Wide Web, for example, database servers specify URLs as a parameter to make connections to it. Similarly any Client-Server application following a particular protocol may specify a URL format as part of its communication process.

In general, the term “file” as used herein refers to sequences of bits or “data sets”. Thus a file may be the contents of a file, a portion of a file, a page in memory, a program executable by a processor, an object in an object-oriented program, a digital message, a digital scanned image, a part of a video or audio signal, or any other entity which can be represented by a sequence of bits.

The term multimedia content refers to the use of several different media to convey information, such as, for example, text, audio, graphics, animation, video and interactivity, and the like. Multimedia also refers to data storage devices, especially those used to store multimedia content, for example, compact discs (CD), digital video discs (DVD), compact flash (CF), secure digital (SD), USB Stick, etc.

The term Pointer is a string of characters, conforming to a standardized format that is used to designate stored content locations (such as a document or an image) by its location. For example, http:///www.uspto.gov is an internet Pointer for displaying a web page, while file://c:/text.txt is a Pointer that identifies a local file on a computer.

The term “profile” is used to define configuration settings and other data associated with an individual user or with a group, such as family, business, a legal case, a surgical procedure, a game, etc., and are typically comprised of files.

The term “iconic representation” is an image, picture, sign or likeness that stands for an object by signifying or representing it by analogy. Iconic representations can be formed in plastic or metal, carved in stone, embroidered on cloth, done in mosaic work, displayed on a monitor, printed on paper or metal, etc.

The term “switch” herein is defined as any implementation for selecting a pointer and may comprise, for example, a set of buttons, a rotary switch mechanism, a combination of a resistor and switch, a variable resistor, a software module or command, and the like.

In the following description, specific details are given to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, structures and techniques may not be shown in detail also in order not to obscure the embodiments.

Also, it is noted that the embodiments may be described as a process that is depicted as a flowchart, a flow diagram, a structure diagram, or a block diagram Although a flowchart may describe the operations as a sequential process, many of the operations can be performed in parallel or concurrently. In addition, the order of the operations may be rearranged. A process is terminated when its operations are completed. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, or a combination thereof. When implemented in software, firmware, middleware or microcode, the program code or code segments to perform the necessary tasks may be stored in a machine-readable medium such as a storage medium or other storage(s). A processor may perform the necessary tasks. A code segment may represent a procedure, a function, a subprogram, a program, a routine, a subroutine, a module, a software package, a class, or a combination of instructions, data, structures or program statements. A code segment may be coupled to another code segment or a hardware circuit by passing and/or receiving information, data, arguments, parameters or memory contents. Information, arguments, parameters, data, etc. may be passed, forwarded or transmitted through a suitable means including memory sharing, message passing, token passing, network transmission, etc.

Various embodiments provide a system, method and device for interactive data management. There are, however, other embodiments that can be used for interactive data management and this disclosure is merely illustrative of and not restrictive on the broad invention.

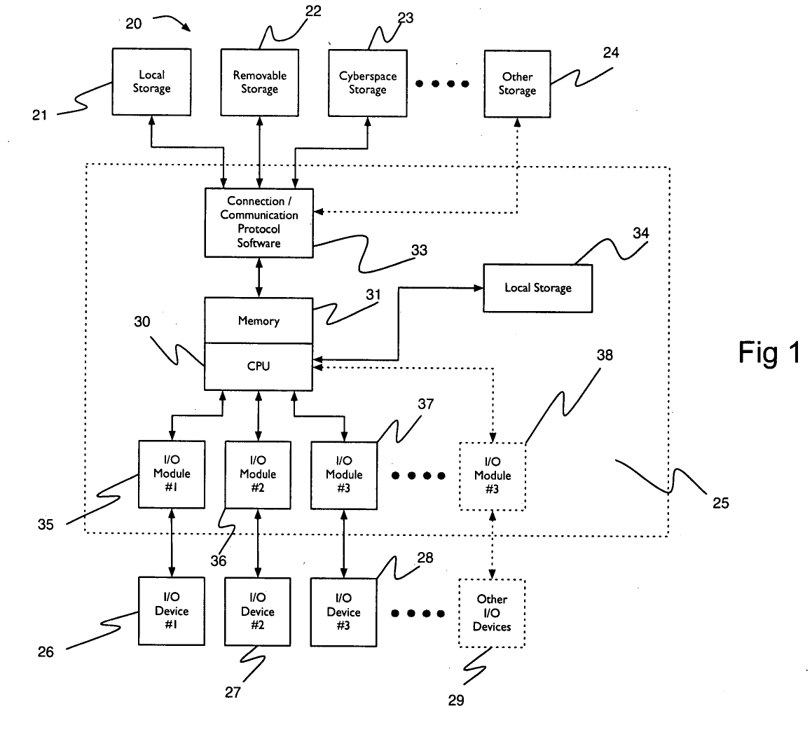

FIG. 1 is a block diagram of a system 20 operative in accordance with one embodiment of the invention. The system includes a processor represented by a dotted line and designated by the numeral 25. The processor, illustratively, comprises a computer with a CPU 30 and memory 31 with various 1/0 modules 35, 36, 37 . . . 38 and connection/communication protocol software 33 with local storage 34 which could reside in memory 31.

Various storage mediums 21, 22, 23 24 representing local PC storage medium, removable storage medium, cyberspace storage medium and other storage medium respectively are operative under the control of the connection/communication protocol software. Similarly, various I/O devices 26, 27, 28 29 are connected to I/O modules 35, 36, 37 38 respectively.

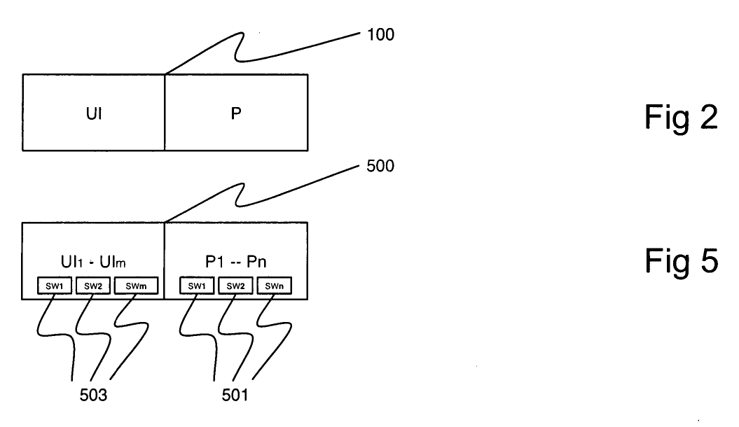

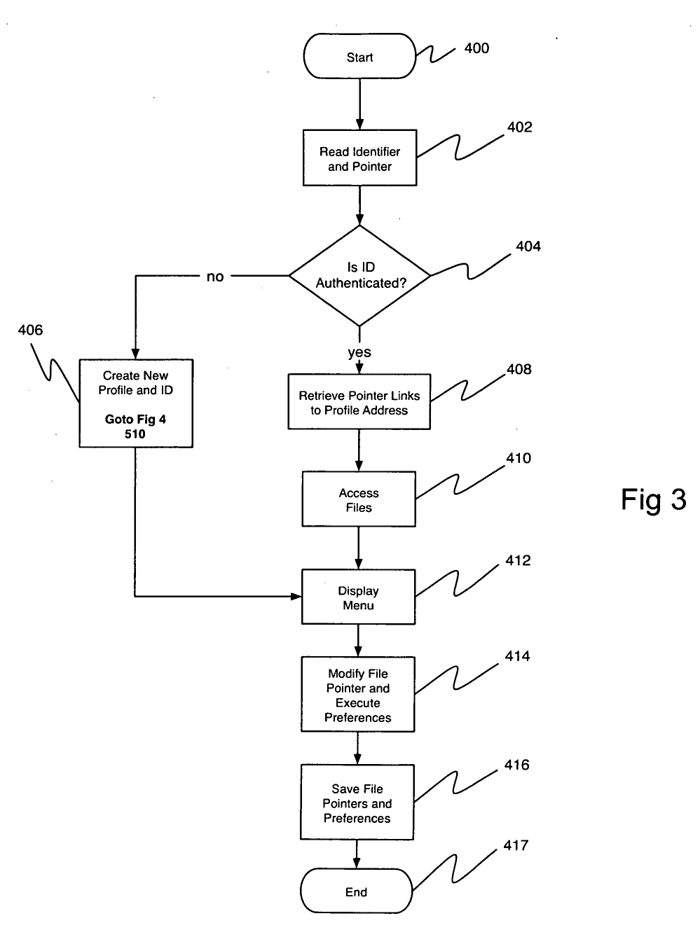

FIG. 2 shows a representative access (or memory) device 100 for accessing a system, for example, the system of FIG. 1. Memory device 100 is an example of I/O device 26 of FIG. 1. Device 100 comprises an identifier (UI) and a pointer (P). The memory device is read by a reader, such as the I/O device 26 in FIG. 1 and software residing in 33 of FIG. 1, and responds as described in connection with the flow diagram of FIG. 3.

The software represented in FIG. 3 is invoked when a memory device is read by a reader, as indicated at 400 in FIG. 3. The identifier (UI) in the memory device is read as indicated at 402. If the identifier (UI) is already stored in the system, it is authenticated in 404. The pointer (P) in the memory device is then allowed to link to (retrieve) the profile address at which the locations of files related to the identifier are stored, in block 408. The files are accessed and executed as indicated at 410.

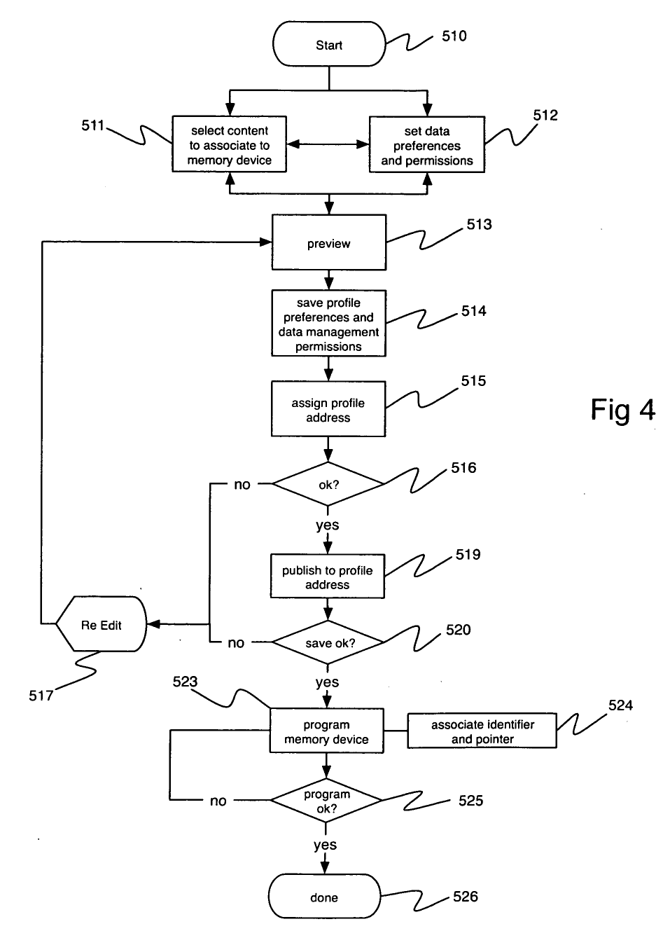

If the identifier ID is not stored in the system, a new profile and identifier are created as indicated at 406. An exemplary flow chart for creating a new profile and identifier is depicted in FIG. 4

A menu is then displayed as indicated at 412 to modify files and execute preferences as indicated at 414. The file pointers and the preferences are then saved in a memory, for example, a local memory 34 of FIG. 1, as shown at 416. The program ends as indicated at 417.

FIG. 4 represents an exemplary flow diagram of a software for creating a new profile (pointer) and an identifier and for collecting related storage locations at a profile address in memory.

Operation is initiated by a signal from memory device as indicated by block 510. In block 511, a user selects content and assigns content associated to the memory device through normal content selection means such as search, drag and drop, browse and select, internet search and select , and the like.

Next in block 512, the user designates preferences as to the manner content is displayed or accessed. For example, the sequence of content display, access permission of editing such as read, write or deletion, read/write only, read writable, read only access, life span, and the like.

The content is then previewed as indicated by block 513. The preferences and data management permissions are saved in block 514. Profile address are then assigned in by block 515. The software then prompts a decision to continue or reedit in block 516. If decision is to reedit, the response is NO and block 517 indicates a return to block 513.

If the decision is to continue, profile address is published as indicated by block 519. The address may be published locally, remotely or on a removable storage.

If the user decides (520) to save the profile address, the memory device is programmed whereby an identifier and pointer are associated as indicated by blocks 523 and 524. If the program is successful, the operation is complete as indicated by blocks 525 and 526. If an error occurred, the software returns to steps of blocks 523 and 524.

FIG. 5 is a schematic representation of a memory device 500 with one or more identifiers UI1, . . . UIm and a plurality of pointers P1, . . . Pn. The memory device in this embodiment includes one or more switches indicated at 501 and 503. Switch(es) 501 are user operative to select a particular pointer and Switch(es) 503 are user operative to select a particular identifier. Thus, in the embodiment of FIG. 5, the user is able to selectively choose one or more identifiers or pointers.

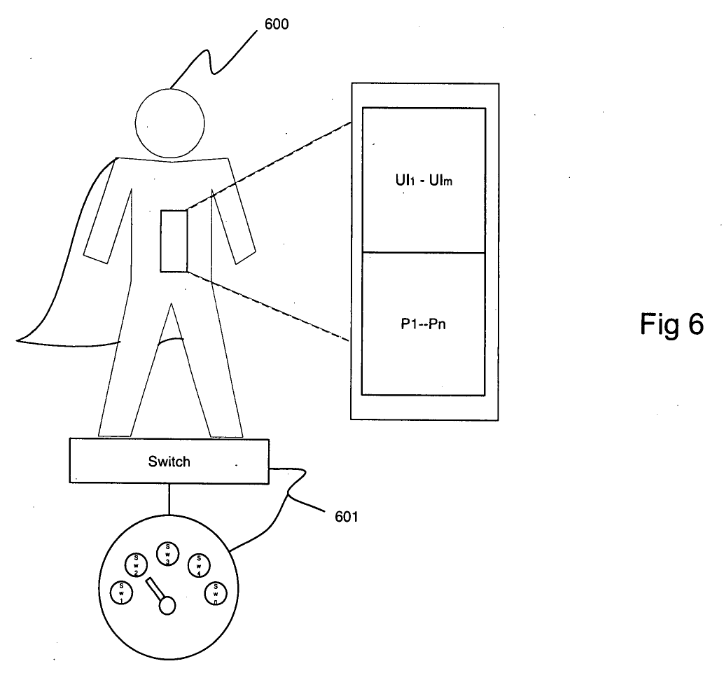

FIG. 6 shows an article 600 in which an identifier and a plurality of pointers are embedded. The embodiment includes a rotatable base member 601 operative to select a particular pointer. Once a particular pointer is selected the operation is similar to these as described in connection with FIGS. 2, 3 and 4. The article in this embodiment may comprise a figure, an iconic representation, an image, a sign, a likeness, a talisman, and the like, as mentioned herein before.

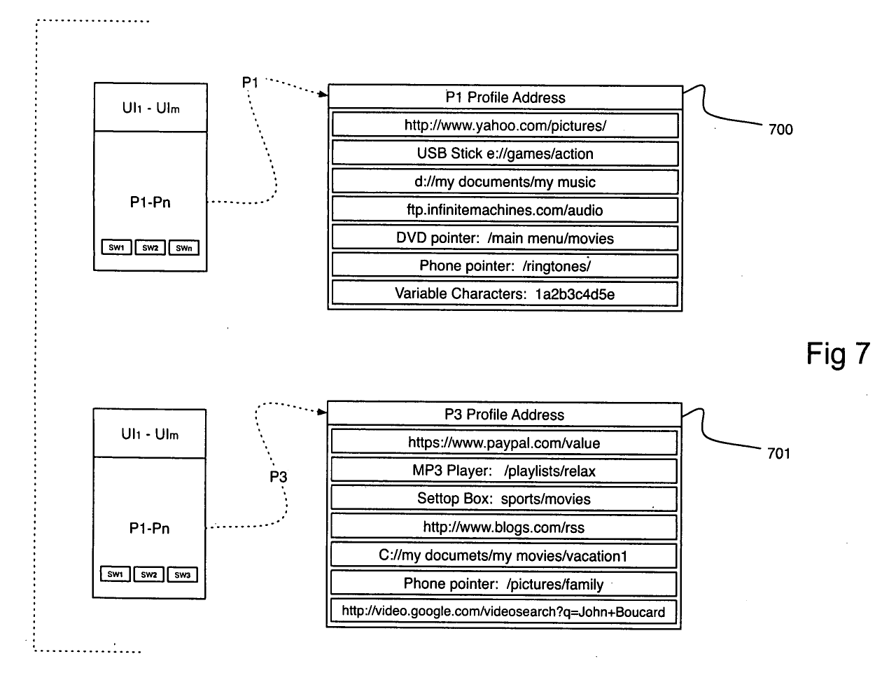

FIG. 7 shows a plurality of alternative location collectives as well as the associated profile addresses and relations to the corresponding pointers. Specifically, FIG. 7 shows an example of content locations stored at profile address P1 selected from a readable memory (or I/O) device. The locations correspond to content related to pictures, games/action, music, audio, movies and ringtone reading from top to bottom in table 700.

FIG. 7 also shows a chart designated 701 when pointer P3 is selected. The chart includes locations corresponding to Paypal™ values, play lists, sports/movies, blogs, vacation movies and family pictures. Profile addresses P1 and P3 are selected by activating switches SW1 and SW3, respectively.

In one embodiment, the memory device may take the form of a plastic strip of about the size of a Band Aid™ as shown in FIG. 2 and may be used as a label or tag. The strip has an adhesive back covered by a release paper. The strip itself comprises a double strip which packages a CPU and memory and is adapted for wireless communication of an identifier and a pointer stored in the memory. In practice, the strip is removed from the release paper and attached to an object representative of the content (or data sets) stored according to a user selected profile.

Each data set stored according to the profile is stored in a medium at a location encoded as belonging to the profile. That location is stored at an address to which the pointer on the “label” links. In this manner, the storage locations of all the data sets belonging to the profile are collected at the “profile” address (see FIG. 7) to which the label pointer links. The identifier is operative to allow access to the profile address only by the holder of the label.

The software for programming the CPU and for responding to wireless signals from the CPU are stored in a memory, for example, 24, 31 (or 34) of the system represented in FIG. 1. The system is thus operative to choreograph a virtual “world” under the direction of a user of the “label” and the label attaches to an object representative of that world as discussed in connection with FIGS. 6 and 7. In one embodiment, the object may be a greeting card, a photograph, a toy figure, a Fantasy Figure, or any physical object having relevance to the stored content.

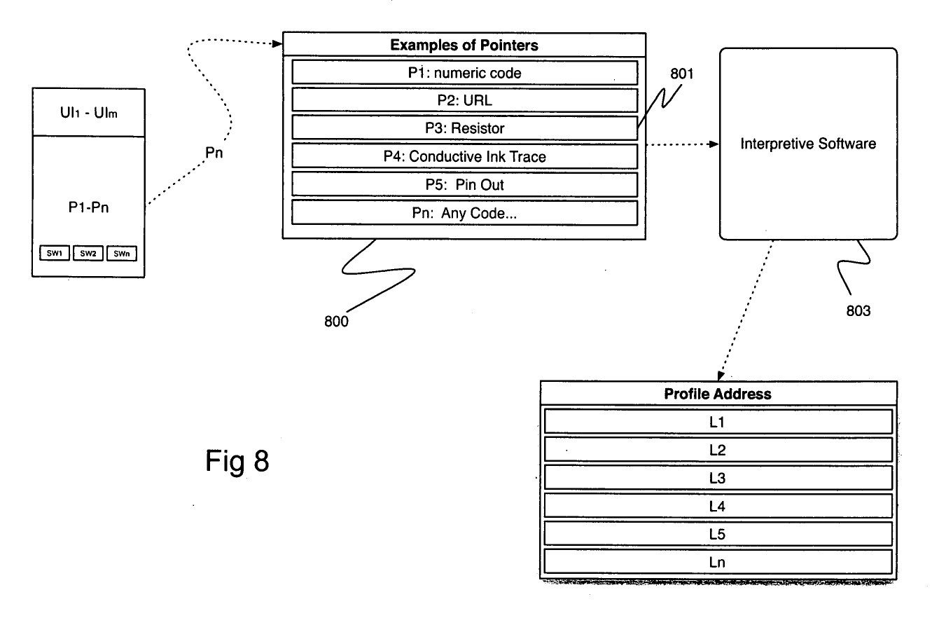

In one embodiment, the “label” (or article) may include an identifier and/or a pointer each encoded in different forms such as a resistor, an (conductive) ink trace, a key pad or key code, a RFID, a pin out, and the like. The label may include codes which can be transmitted wirelessly. If one (or both) of the unique identifiers and pointers are of a form which cannot be transmitted, the system would include a suitable decoding instrumentation for the reader to respond. For example, a switch (SW1 of FIG. 5) coupled with a resistor (ID) embedded within a USB Stick (e.g., 25 of FIG. 1) could serve in this manner. The selection of a pointer is interpreted by interpretive software (e.g., 803 in FIG. 8) which resides, for example, in one or more of the storages 33, 34, 21, 22, 23 and 24 of FIG. 1.

FIG. 8 shows a chart 800 of six examples of pointers stored in a memory. The selection of a particular pointer, using the buttons (501 of FIG. 5) provides an identifier (UI) and one pointer (e.g., P3) which may be a resistor as indicated at 801. When the pointer is selected and read by a reader, access is provided to the selected profile address (e.g., P3 of FIG. 7) and to the related locations L1 . . . LN (not shown) stored therein, as shown in FIG. 8 and which include the locations shown at 701 in FIG. 7.

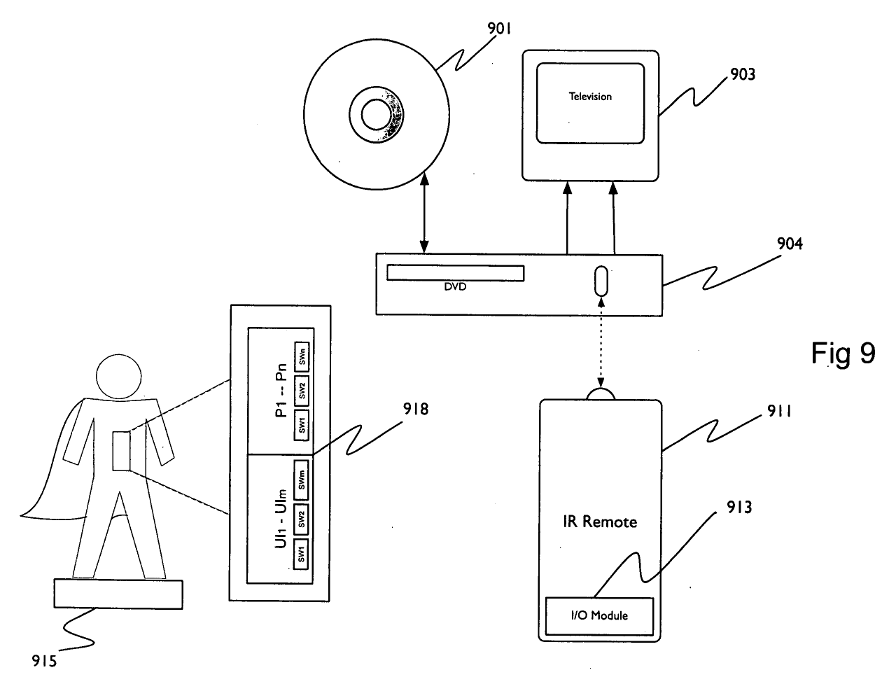

FIGS. 9-16 show some exemplary applications of the invention. Specifically, FIG. 9 shows a disk (e.g., a DVD) 901, a television 903, a DVD player 904 and an IR remote 911 with a resident I/O module 913 (e.g., 32 of FIG. 1). The memory device (FIG. 2 or FIG. 5) in this instance is embedded in a themed representation 915.

Typically, a child has trouble interpreting the numerous buttons on a standard remote control. For example, there might 30-40 buttons on the remote and specific types of words that the child may not be able to read. FIG. 9 details an embodiment whereby the child need not understand any words on the remote at all, instead the child uses a themed device 915 that may be wireless and interfaces it with a IR remote control 911 that has the ability to interpret embedded unique identifier(s) and pointer(s) 918.

With this embodiment, a child that has a stuffed toy or a themed character can pass (scan) it in front of the IR remote control 911 and activate a specific piece of content shown on a standard television set 903. A child that may be younger can collect a series of themed toys that may be, for example, a collection of small plush animals. The child chooses a lion from the collection of animals and walks up to the television set 903 with a standard DVD player 904 interfaced to it. The child waves the small plush lion in front of the IR remote control 911 and the remote control sends data to the DVD player 904 to activate a specific DVD movie 901 about a Lion.

Another example is when a user purchases a special box set of a pirate movie DVD 901 along with a small charm that is themed like a small coin. The IR Remote control 911 could be built into the DVD player 904. By collecting a series of special coins, the user can activate behind-the-seen footage by waving (scanning) specific coins in front of the IR Remote control 911 inside or outside of the DVD player 904 case. The IR Remote control communicates with the users standard DVD player and activates a special, specific DVD movie, DVD game, a special menu that the user can navigate through in a special way, and the like.

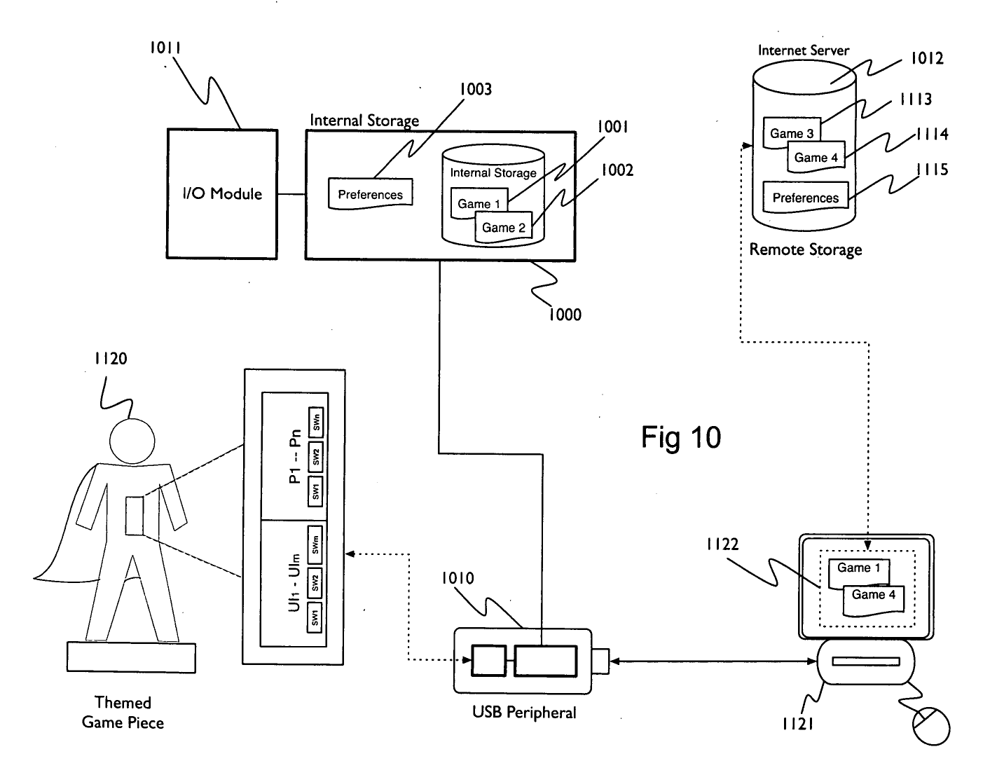

FIG. 10 represents a game application involving the Internet. This embodiment includes internal storage 1000 with game 1 and game 2 stored as indicated at 1001 and 1002. Preferences are also stored as indicated at 1003. The embodiment also includes a USB stick 1010 coupled to an I/O module (i.e. 32 of FIG. 1) designated 1011. Connection to an internet server 1012 is indicated by broken line 1013. The server 1112 provides access to additional game and preference data as indicated at 1113, 1114 and 1115. A themed game piece 1120 is coupled to the USB peripheral (stick) 1010 which, in turn, is connected to a computer 1121. In one embodiment, the themed game piece 1120 and the USB stick 1010 can be combined in a USB device.

A USB game system according to the example of FIG. 10 includes unique identifiers (UI) 1120, Software Application 1122, Internet content and stored games 1001, 1002, 1113, and 1114, and physical displays with data 1121.

The USB stick 1010 and themed games pieces 1120 work together to enable the acquisition, activation, storage, and sharing of content. The USB stick provides ample storage for games, applications and content, connects to the user's computer via an USB port and communicates wirelessly with game pieces 1120. In one embodiment, the USB stick 1010 itself is themed. The game pieces are smaller devices with a more limited storage and a variety of interfaces to USB sticks and physical displays. An example of a physical display might be a movie poster.

Data content and games are played through the Software Application 1122 which may be installed on a user's computer from the USB stick, downloaded from the Internet, or the like. The Software Application manages and activates content, games, activities, and character attributes that a user collects from physical displays, game playing, and interacting with other user's game pieces.

Servers 1012 provide content, games, trading, profile management, and can track a user's points, game progress and character attributes. Each user has a Master Profile under which all game piece activities can be managed. For example, as a user obtains new USB sticks and game pieces, she can add them to her online profile and then use them in multi-player games, trade them, or display them in her virtual online meeting place. Internet content and games are obtained from servers, and Affiliate servers (content can also be obtained from the USB sticks) and presented in the Software Application 1122. The Software Application manages the content, periodically checks for updates and deletes expired content.

Physical displays can be anything from movie posters to kiosks with a form of embedded memory device containing content codes. When a user swipes a game piece at a physical display, or another user's game piece, data is passed wirelessly to their memory device. That data may then be used or activate new content. Typically, this means that the Software Application 1122 uses the code to download, authenticate and present the new content. The authentication process may range from simply confirming that a given data is valid to a complex series of checks taking into account a user's status, stats, location, age, parental controls, and the like. In one embodiment, the authentication occurs both at the Software Application and for remote content, at the Servers 1012.

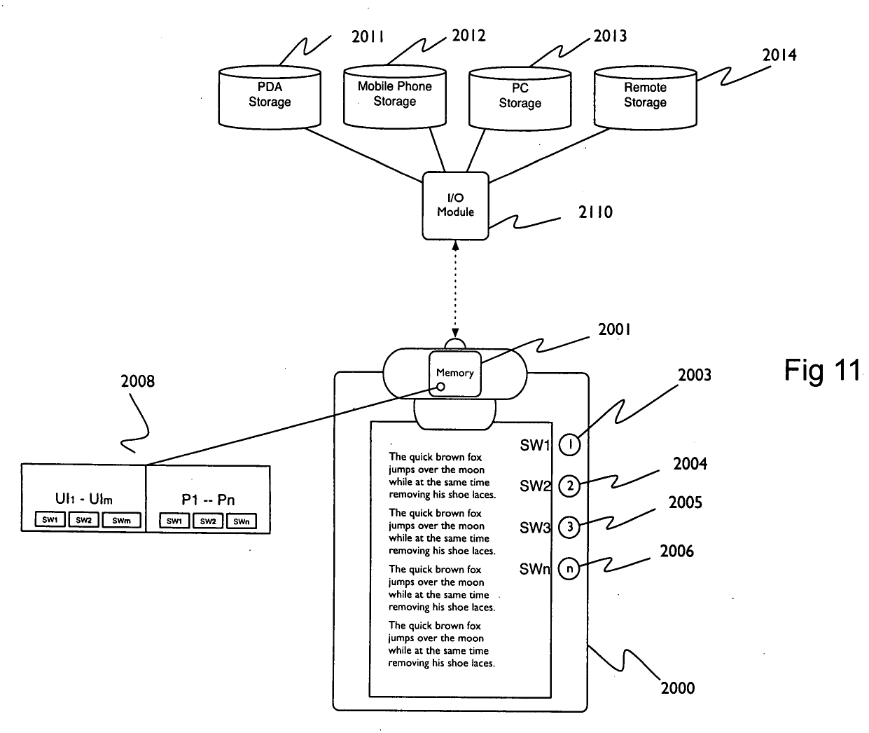

FIG. 11 illustrates an application in which a clip board 2000 is adapted to include a memory device 2001 in which one or more identifiers UI1 . . . UIm and one or more pointers P1 . . . Pn are stored. Pointers P1, . . . Pn and associated switches (SW1 . . . SWn) are designated 2003, 2004, 2005 and 2006. Identifiers UI1 . . . UIm may also have a set of unique identifiers, in this embodiment, these unique identifiers correspond to different patients. A doctor is identified by the identifier 2008. The doctor need only access a computer via I/O module 2110 in the computer to access patient information or content (corresponding to the selected pointer). Profile address includes locations in PDA storage 2011, mobile phone storage 2012, PC storage 2013 and/or remote storage 2014. This way, related data to a specific patient, such as patient history information, x-rays, MRI images, audio reports, and the like become instantly and easily available to the doctor.

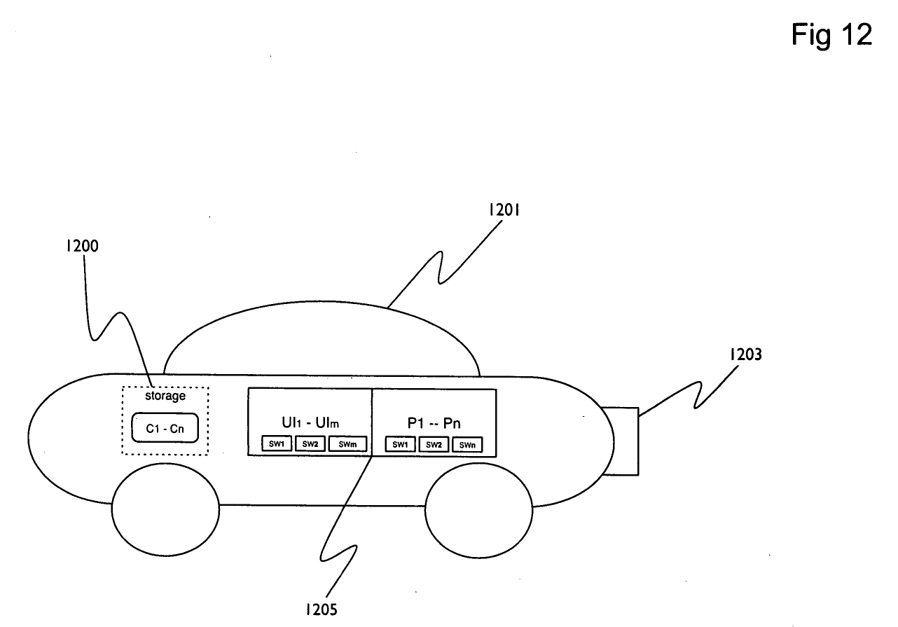

FIG. 12 shows a USB Stick modified to operate as a themed memory device. In this embodiment, a user may collect small cars that have various types of multimedia content stored onboard in internal storage 1200 or linked to via identifiers and pointers 1205. The multimedia content may be stored on the Internet and accessed with a normal browser. In accordance with the principles of the present invention, a themed collectable 1201 is a 2006 Ford Mustang™. The collectable 1201 includes switches which respectively activate pointers P1-Pn and identifiers UI1-UIm, and operate similar to USB stick 1010 of FIG. 10. This way, the user is able to easily access specific information related to the themed car by simply plugging the USB connector part of the car 1203 into a USB port on a computer.

Content related to this specific user and the specific car could change. For instance, lets assume that the user uses the collectible car to access games on the internet and play games with a digital representation of a 2006 Ford Mustang™ in a game race. Points could be earned and stored in the user profile on the Internet. This may be managed by the unique identifiers and saved. The user continues to access these specific games on the Internet or use games preprogrammed and stored in an onboard memory. This way, the user could (digitally) increase the collectibilty of the physical device, that is, the Ford Mustang™ becomes collectible from a physical perspective. Also, because the games (or scores) stored in the onboard memory or on the Internet, the user actually affects the outcome of the collectibility. In one embodiment, There is no memory onboard for storing the games and all the games are stored and located on the Internet.

The user could also access specific information about the year and model of the car, share experiences of this type of car online with others, buy digital accessories for the collectible, and the like. These features could all be accessed and governed by the identifiers (user profiles) and pointers.

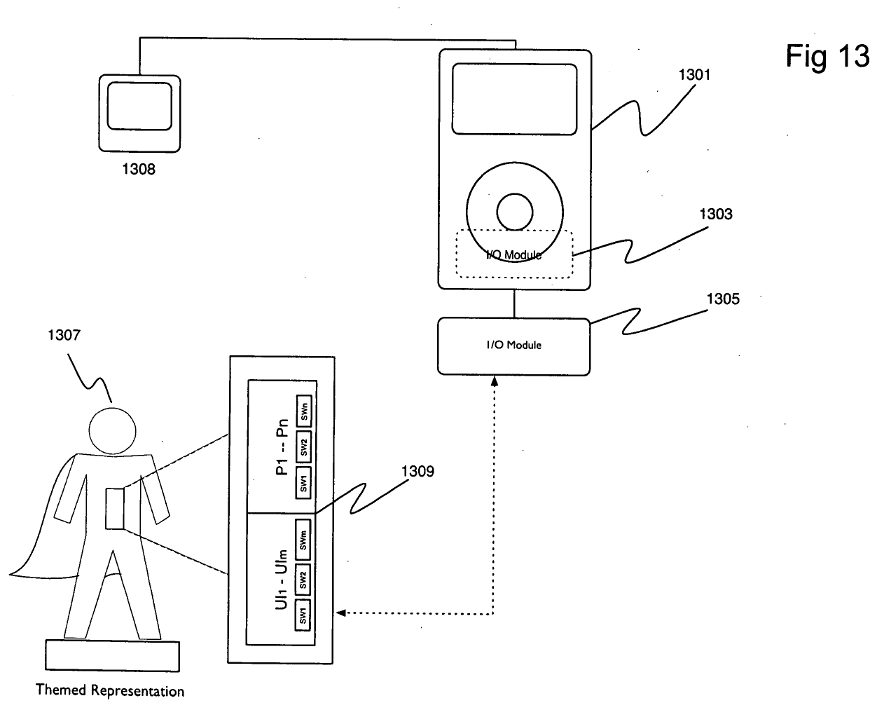

FIG. 13 illustrates an application for a multimedia player (for example, an IPOD™). Many people use multimedia players to store and manage personal music, podcast, and video collections as well as phone numbers and calendars to name a few features. They use standard interfaces to activate and view content on these multimedia players. As shown in FIG. 13, a user can activate and manipulate data on a multimedia player 1301 simply be interfacing with an iconic/themed representation (object) 1307 of what is stored on the multimedia Player. For example, a user could waive a calendar themed object including one or more identifiers and pointers 1309 in front of multimedia player equipped with an I/O module 1303. Because the iconic object is themed like a calendar and has the necessary pointer(s) and identifier(s) associated with data stored on the media player, the device swiftly activates all calendar data stored on the device relative to the specific user.

Another example is an iconic representation of a specific music band. By waiving (scanning) a themed representation on front an equipped multimedia storage/player device 1301, a specific band and song are displayed and played, for example on a television or a PC 1308 coupled to the multimedia storage/player device 1301 via connection 1300. Other objects such as movie themed objects, cartoons, or even pictures of contacts could activate relevant multimedia files associated with the themed objects in a portable way on the go or perhaps also when the media player is interfaced with a personal computer or game console. The user may want to listen to a specific podcast or video blog stored on the device. To access this type of data, the iconic representation device stores a specific identifier and pointer to automatically call up the newest podcast or video blog of the specific time period.

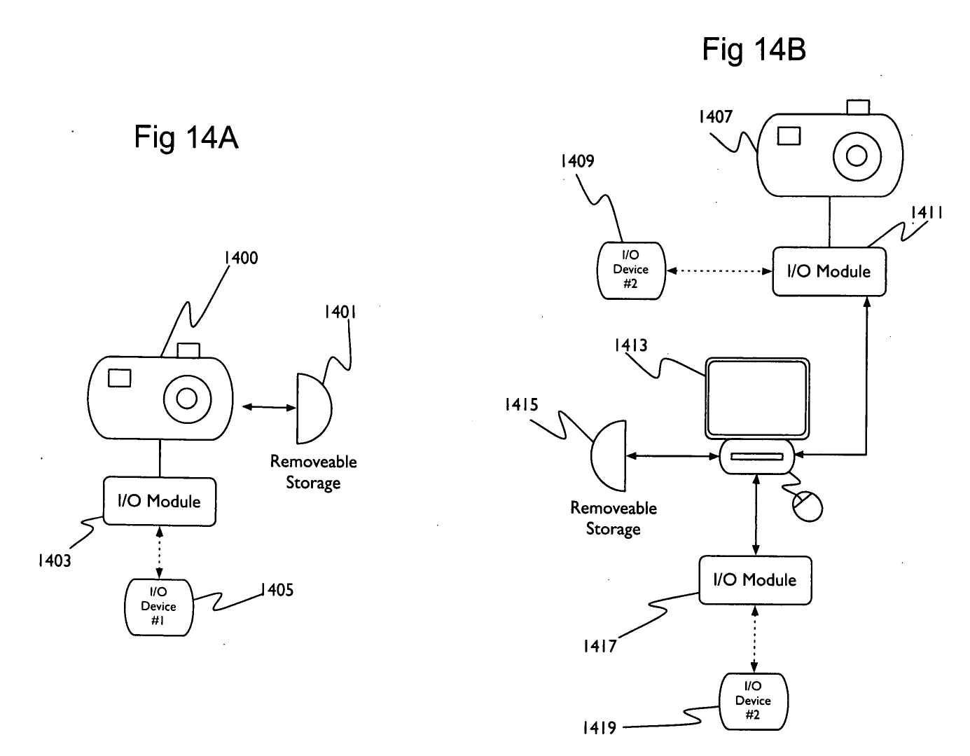

FIGS. 14A and 14B depicts a game application involving an unique storage means and access to content, according to one embodiment of the present invention. With certain types of consumer products, there is a need to access specific types of content instantly, instead of having to navigate poorly designed user interfaces built on board. For instance, a digital camera 1400 is able to capture large volumes of digital pictures and store them on a removable storage device 1401 or any kind of storage device, as shown in FIG. 14A. An I/O device 1405 is themed or molded into certain shape that becomes a representation of the stored content on the camera's removable store. The themed I/O device 1405 may be a regular printed picture of the user or perhaps someone whose picture is stored. When the user desires to call up an image or a specific album stored on a storage device, a reading device 1403 embedded in or attached to the camera 1403 reads the identifier and pointer to access relevant digital data.

FIG. 14B illustrates an application when a user desires to activate a collection of digital data in the form of pictures from a PC 1413. By using a collection of one or more of I/O devices 1419 and a reading device (I/O module) 1417, the user can activate pictures or entire albums stored locally, externally in storage 1415, or on the Internet. This data can be viewed on a personal computer 1413 or a camera 1407 that is interfaced with a computer and has a reading means 1411. The camera that is plugged in may be a reader as well. The activating of collections of digital pictures and digital movies is becoming more and more important because these types of capturing devices can collect literally thousands of clips with old fashion user interface means of navigating through them. It becomes a tedious task. With a simple and easy to use unique identifier and pointer system and method of the present invention, anyone can associate an album or singular data types with a themed object so that he/she can immediately have access to relevant digital data.

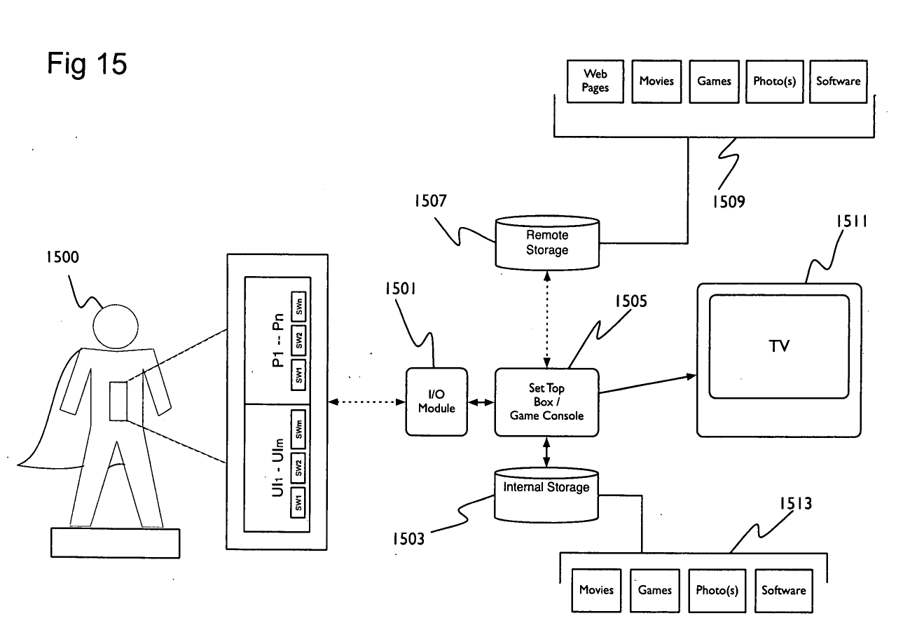

FIG. 15 shows a set top box application of the present invention. Television and the access to content via the television is constantly changing. There are more channels and the access to data related to shows through set top boxes like a satellite box or cable box are dominating how people watch television. The means to navigate this content is complicated and requires the user to use a remote control with all kinds of different buttons and a TV menu that is full of data, text, times, etc.

Here, a themed object with an embedded unique identifier and pointer 1500 is read by an I/O module 1501 and interpreted to access specific types of data (web pages, movies, games, photos, software, and the like) 1509 and 1513. The data may reside on a set top box 1505, or accessed from remote storage, for example, a server 1507 or a local storage 1503 related to how the user programs his/her favorite channels, DVR features, access to movies, web pages, games, pictures, and other types of software. With this system, the user can edit preferences and enjoy a unique customized experience with the television set.

A child could wave (scan) a themed device in front of the television an initiate a series of preferences and controls for specialized programs that are educational in nature that relate to the themed object that could a cartoon character for instance. Parents may use software to modify the unique identifiers and pointers on the themed object to adjust levels of security or channel preferences once the child introduced the themed object again in front of the television. For example, the child's grade level and age may be stored and activated by the one or more stored identifiers to access the Internet to pull down games or access an onboard storage whereby the child can play and watch games and shows that relate to specific types of educational content. The child can easily collect and organize show icons based on interactivity with the games, shows and content interpreted by the reader device and the displays to view and display content through a television system 1511.

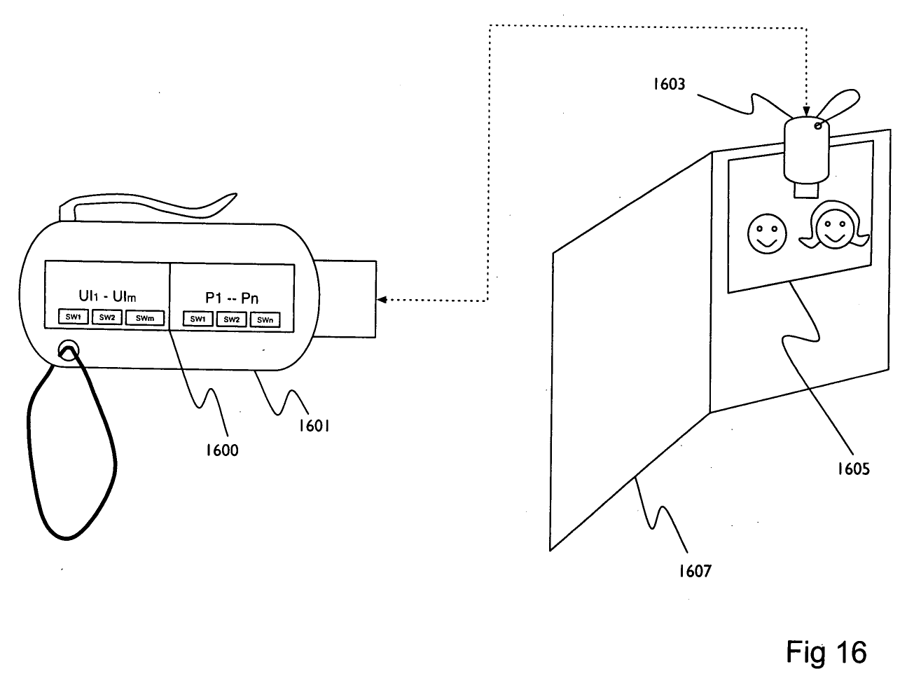

FIG. 16 shows a greeting card application of the present invention. For years greeting cards have been printed and customized with hand written notes and comments. They are usually mailed or given by hand from the giver (creator) and read by the receiver governed by a “reason” (e.g., birthday, holiday, feeling, etc.). Printed greeting cards are a form of physical self expression. In one embodiment, the present invention provides a user (a giver) with the ability to visually choose a themed form factor that expresses a feeling related to a “reason.” Additionally the user may clip or adhere the memory device of the present invention to a second article (for example, a regular old fashioned greeting card). This way, the present invention provides the user with the ability to physically and digitally craft a custom collection of relevant digital media to activate on a computer, phone, or television viewer by interfacing the themed object and pointing to or activating from various storage mediums.

For example, a husband may wish to create a greeting card according to an embodiment of the present invention for his wife by choosing a series of pointers that link to series of relevant movies or videos on a destination website. The husband may also desire to point to a website like Ophoto™ or Flickr™ to display still digital photos of a past event that he and his wife shared. A link to an Itunes™ song on the Internet may also be added by modifying and editing the pointers in the system.

Additionally, a purchaser may want to purchase a digital certificate from a website on the Internet and then link the URL of the website to the pointer on the themed object. Utilizing an embodiment of the present invention, a giver can pre-purchase value and display that value in the form of a web page when the receiver of the greeting card of the present invention activates all the different types of media. The giver essentially can combine a variety of multimedia elements activated by the pointers that he or she crafts in a digital way, but gives and shares physically by attachment to a physical object.

The invention herein is described merely as an illustration thereof. It is to be understood that the disclosure is made by way of example and various changes and modifications could be made by those skilled in the art without departing from the spirit and scope of the invention as encompassed by the following claims.

What is claimed is:

1. A system for linking an article to data comprising:
a processor with a memory;
a plurality of storage mediums operatively coupled to said processor;
a readable memory device included with the article, the memory device including an identifier and a pointer, wherein the identifier uniquely identifies the article and the pointer links to one or more locations of data related to a user-defined profile;
a reader for reading the identifier and pointer; and
an output device operably coupled to said processor for outputting the data related to the user-defined profile.

2. A system as in claim 1 wherein said article comprises an object representative of the data related to said user-defined profile and said memory device is embedded in said object.

3. A system as in claim 1 wherein said article comprises a tag and said tag includes said memory device and means for attachment to an object.

4. A system as in claim 1 wherein said article comprises a plastic strip with an adhesive backing for attachment to an object.

5. A system as in claim 1 wherein said memory device includes an identifier and a plurality of pointers and said article includes means for selecting a pointer from said plurality of pointers.

6. An article of manufacture comprising:
an identifier; and
a pointer, wherein said identifier uniquely identifies the article and the pointer identifies one or more locations of all content associated with the article.

7. An article as in claim 6 wherein said article comprises a physical representation of the stored content.

8. An article as in claim 6 wherein said article is an iconic representation of the stored content.

9. An article as in claim 6 wherein said article is a photograph.

10. An article as in claim 6 further comprising means for attaching the article to a physical object.

11. An article as in claim 6 further comprising a physical object having relevance to said content.

12. An article as in claim 6 wherein said article is a greeting card associated with the stored content.

13. An article as in claim 7 comprising a toy figure associated with the stored content.

14. An article as in claim 7 comprising a Fantasy Figure associated with stored content.

15. An article of manufacture as in claim 6 wherein said identifier includes a plurality of pointers, said article including means for selecting one of said plurality of pointers.

16. An interactive data management system comprising:
storage means responsive to an article remote from the storage means, the article including an identifier and a pointer for storing a plurality of data sets each related to a user-designated profile, each of said data sets being stored at a different designated storage location; and
means responsive to said identifier for activating the data sets at said storage locations according to a preset user preference.

17. A system as in claim 15 further comprising means for simultaneously activating all of said data sets.

18. A system as in claim 15 wherein said pointer includes one of the group consisting of a key code, a URL, a conductive ink trace, a resistor, an RFID, and a pin out.

19. A system for accessing related multimedia content stored in various mediums comprising:
a plurality of storage devices each for storing data representative of a different medium;
a processor including software for recognizing data as belonging to a user-defined profile;
a memory; and
a memory device including an identifier and a pointer linked to an address in said memory storing locations of the data representative of a different medium in respective storage devices, wherein said software being operable responsive to said identifier and profile for accessing said data.

20. A method for storing related content elements in various storage mediums, said method comprising:
identifying content elements as belonging to a user identified profile;
storing each content element at a storage location in memory encoded as belonging to the profile;
collecting the storage locations at a profile address;
transmitting a signal linked to the profile address; and
publishing the content elements in the locations stored at the profile address responsive to the signal.

21. A method as in claim 20 further comprising storing in a readable memory device an identifier and a pointer linked to the profile address.

22. A method as in claim 20 wherein the content elements are stored in accordance with a user preference code.

23. A method as in claim 22 further comprising editing the user preference to add or delete content elements in the user profile.

24. A method as in claim 22 further comprising editing the profile address to add or delete content element locations therefrom.

25. A method as in claim 22 further comprising publishing the content elements stored in the locations collected at the profile address according to the user preference code.

26. A method as in claim 22 wherein said user preference code comprises one or more unique identifiers and one or more pointers.

27. A device for linking an article to a plurality of content elements stored in various mediums coupled to a processor comprising:
a base;
means for attaching the base to an object;
a memory for storing an identifier and a pointer, wherein the identifier uniquely identifies the device and the pointer links to a profile at which the locations of all said plurality of content elements are stored; and
a reader for reading the identifier and the pointer, wherein the processor accesses said plurality of content elements responsive to the identifier and the pointer read by the reader.

28. A device as in claim 27 wherein the memory stores a plurality of pointers each linked to a different profile address, the device further comprising a switch for selecting a single one of the plurality of pointers.

29. A device as in claim 27 wherein said base is embedded in an object representative of the profile.

30. A device as in claim 28 wherein said base is embedded in an object.
